(19) United States
(12) Patent Application Publication
(10) Pub. No.: US 2006/0166782 A1
(43) Pub. Date: Jul. 27, 2006

(54) Quiet, vibration-free superimposed transmissionfor a superimposed steering system

(76) Inventors: Bayer, Muhlheim (DE); RoJohann Jungbecker, BAdenheim (DE); Steffen Linkenbach, Eschborn (DE); Joachim Nell, Hanau (DE); Norman Muth, Frankenberg (DE)

Correspondence Address: Gerlinde M Nattler;Craig Hallacher, Continental Teves Inc, One Continental Drive, Auburn Hills, MI, 48326, US

(21) Appl. No.: 10/536,655

(22) PCT Filed: Nov. 27, 2003
(86) PCT No.: PCT/EP03/50904

§ 371 Date: Dec. 29, 2005

(30) Foreign Application Priority Data
Nov. 29, 2002 (DE) 10255718.7

(51) Int. Cl. F16H 57/08; F16H 57/00

(52) U.S. Cl. 475/345; 74/411

(57) ABSTRACT

In a superimposition transmission for a superimposition steering unit, in which a steering angle set by the driver can, in the event of need, be superimposed by an additional angle, with at least two toothed gears, at least one first toothed gear in the transmission is provided, which toothed gear is designed with reference to low noise level and assumes the transmission of force and, in the event of a normal transmission function, at least one second toothed gear is provided in the transmission, which toothed gear is designed with reference to the transmission of force in the event of a transmission function overload.

### BACKGROUND OF THE INVENTION

The invention relates to a superimposition transmission for a vehicle, in which a steering angle set by the driver can, in the event of need, be superimposed with an additional angle by means of at least two toothed gears.

The objective of the invention is to create a transmission that guarantees an operation that is low in noise and free of clearance.

### SUMMARY OF THE INVENTION

In accordance with the invention, it is essential for at least one first toothed gear to be provided in the transmission, which is designed with reference to low noise level and which assumes the transmission of force in the normal event of transmission function, and that, at least one second toothed gear is provided in the transmission, which toothed gear is designed with reference to the transmission of force in the event of an overload of transmission function.

By means of the design, an adjustment to different requirements can be achieved for different applications, particularly low-noise operation, with a simultaneous relatively high mechanical carrying capacity.

In the sense of the invention, the term “transmission” is to be understood in a broad manner. Preferably, however, rotation/rotation transmissions, which have at least one step or transmission positions with at least two rotation/rotation transmissions, which are actively connected by corresponding means, are to be understood by this.

The transmission is preferably a superimposition transmission for a superimposition steering unit. Superimposition steering units are characterized in that an additional angle can be superimposed on the steering angle set by the driver by means of an actuator. The additional angle is defined by a control unit, and serves to increase the stability and the agility of the vehicle. There is also the possibility of compensating for disturbance variables and achieving the gradient wheel steering angles by means of steering wheel angles as a function of the driving speed of the vehicle. Hydraulic or electrical actuators are used.

A low-noise operation, with a sufficient mechanical carrying capacity, can be achieved by means of the invention, which operation is particularly advantageous for use in a motor vehicle.

In the development of the invention, it is provided that the first toothed gear is designed with reference to low vibration level and/or low clearance.

It is provided, in accordance with the invention, that the event of a transmission function overload is present from a specific momentum boundary value, which the transmission does not exceed in a normal operating mode (normal transmission function event).

In accordance with the invention, it is provided that the second toothed gear comes into engagement after a defined elastic deformation of the first toothed gear.

The task is also solved by a transmission in which at least one first toothed gear and one second toothed gear are provided in the transmission, where the first and second toothed gears have different physical characteristics.

The transmission is preferably a superimposition transmission for a superimposition steering unit. Superimposition steering units are characterized in that an additional angle, one that is additional to the steering angle set by the driver, can be superimposed by means of an actuator, if needed. The additional angle is defined by a control unit and serves to increase the stability and agility of the vehicle. There is also the possibility of compensating for disturbance variables and of achieving the gradients of the steering angle of the wheel through the angle of the steering wheel as function of the driving speed of the vehicle. Hydraulic or electrical actuators are used. The transmission can be well adjusted to the requirements of a steering transmission through the different physical characteristics of the toothed gears. In particular, a low-noise operation can be achieved.

In one configuration of the invention, it is provided that the second toothed gear is harder than the first toothed gear.

In accordance with the invention, it is provided that the second toothed gear is more stable in shape than the first toothed gear.

In accordance with the invention, it is likewise provided that the first and the second toothed gear have different moduli of elasticity (E-modulus).

In accordance with the invention, it is provided that the first and the second toothed gear consist, at least in one partial area, of a different material or of a different combination of materials, as the case may be.

That means that the entire toothed gear can be produced from one material, or at least that the surfaces that enter into form-locking contact are made of different materials. Long-lasting flexible plastics can be used as the elastic material. The first toothed gear can be covered, on at least one partial surface, with an elastic material. The material may, for example, be applied by means of adhesion, spraying, vulcanization, or other surface coating processes. The core area of the first toothed gear then preferably consists of a metallic material.

In one configuration of the invention, it is provided that a metallic material and a plastic are used as different materials.

In one configuration of the invention, it is provided that the first and the second toothed gear are positioned next to one another in the axial direction.

In accordance with the invention, it is likewise provided that the first toothed gear is radially offset from the second toothed gear by a positive profile displacement.

By that means, it is brought about that only the first toothed gear comes into contact with a corresponding toothing of an additional transmission component during the normal transmission of momentum. Only in the area of an elastic deformation of the first toothed gear does the second toothed gear come into contact with the corresponding toothing of the additional transmission component.

In accordance with the invention, the transmission has a straight gearing or an oblique gearing. A straight gearing is particularly preferred, however.

In accordance with the invention, it is provided that the transmission is a rotation/rotation transmission, preferably a planetary transmission. In principle, the planetary transmission consists of a sun wheel seated on a shaft, in the middle point of the set of planetary units, which has planetary wheels that mesh with the sun wheel and which rotate around the central sun wheel. The planetary wheels rotate simultaneously around their own axis. A planetary carrier unit, which supports the individual planetary wheels, makes this possible. By means of a solid positioning of the wheels or shafts and/or carrier, as the case may be, various driving and output drive possibilities for the planetary wheel transmission can be achieved. A very small construction space can be advantageously achieved by means of the planetary transmission. In addition, its manufacture is relatively economical—because essentially no radial forces arise, simple slide bearings are sufficient.

In accordance with the invention, it is provided that the first and the second toothed gears are planetary wheels within the planetary transmission.

In one configuration of the invention, it is provided that the first and the second toothed gears have a radially soft suspension or support bearing.

The transmission is preferably used in an electromechanical superimposition steering unit (ESAS) (2) for motor vehicles. Other areas of use, with similar requirements, are conceivable.

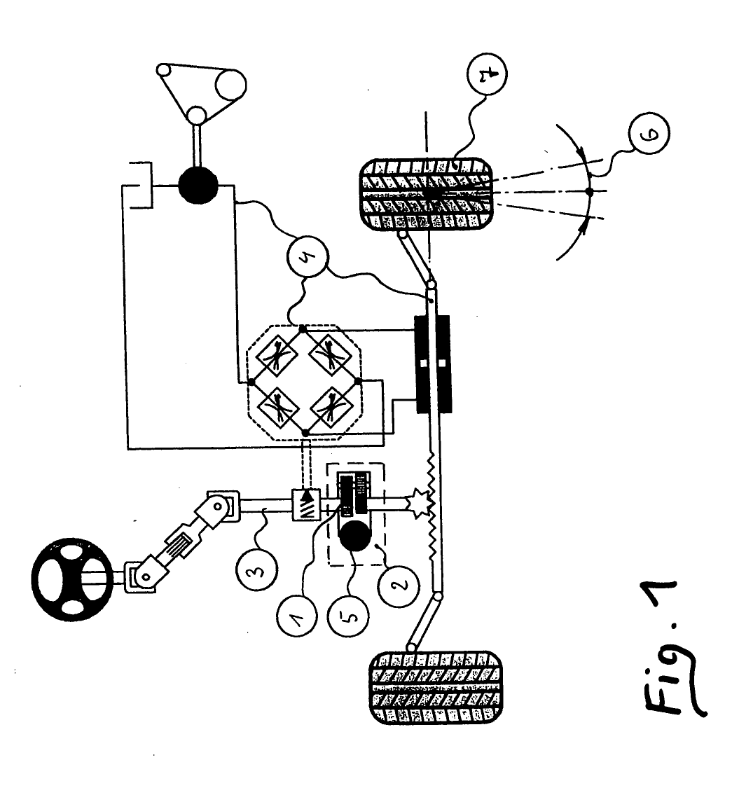

The invention will now be illustrated in further detail by means of one embodiment, and by means of the drawings (FIG. 1 to FIG. 9).

### BRIEF DESCRIPTION OF THE DRAWINGS

In FIG. 1, an electromechanical superimposition steering unit (ESAS), which has a superimposition transmission, is depicted schematically.

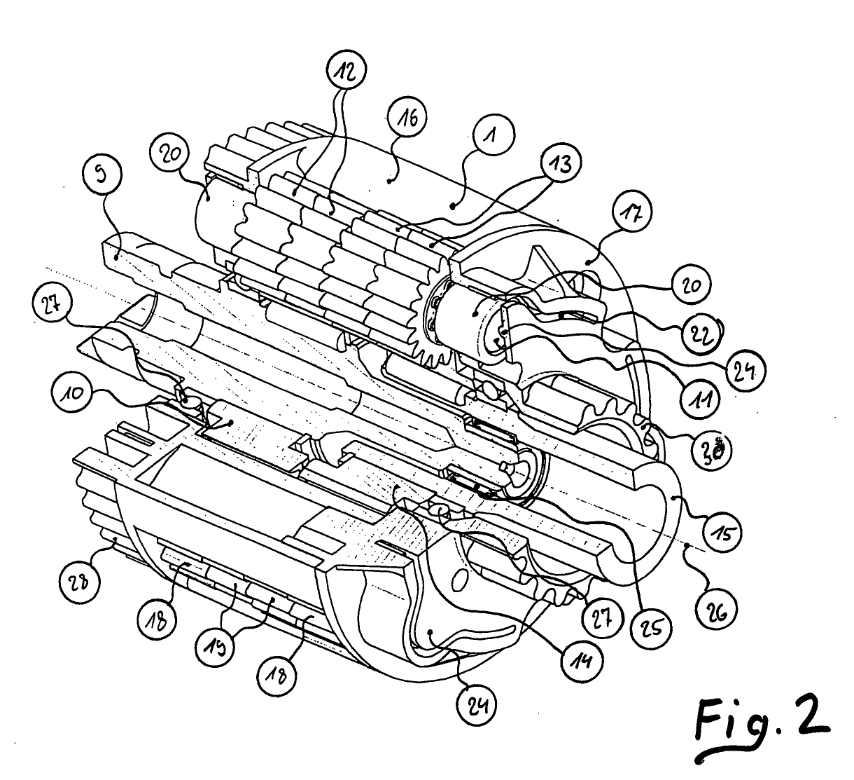

In FIG. 2, a planetary transmission, which planetary transmission is used as a superimposition transmission for steering the vehicle, is depicted in a perspective representation.

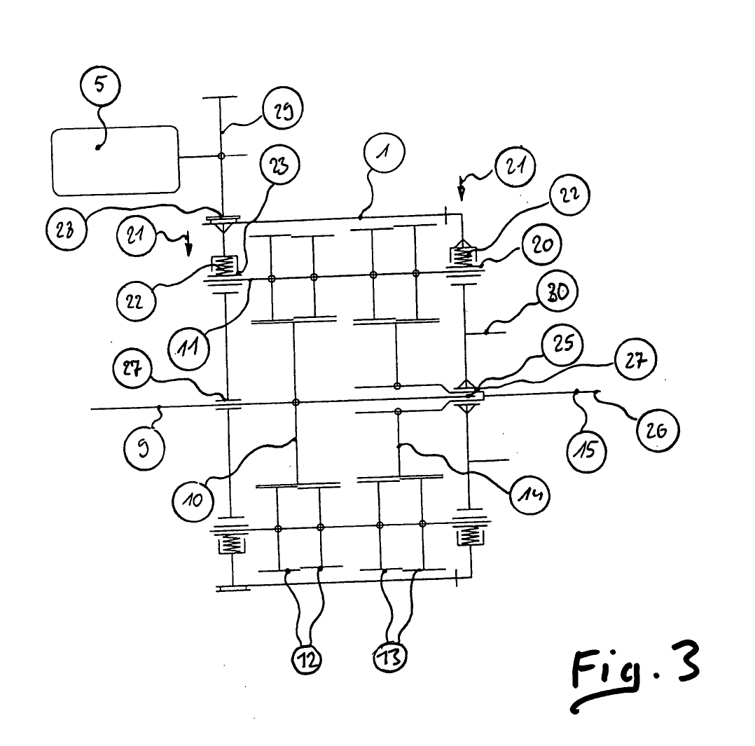

In FIG. 3, the planetary transmission depicted in FIG. 2 is schematically depicted in a cross-section.

In FIG. 4, the planetary transmission depicted in FIG. 2 is depicted in a cross-section.

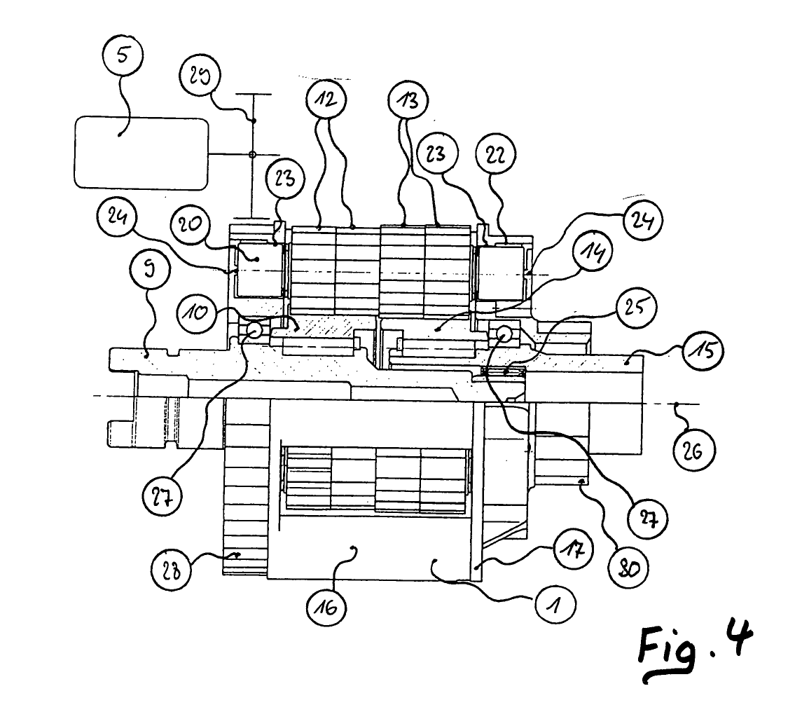

In FIG. 5, a cut-out section in the area of the planetary wheels in the planetary transmission depicted in FIG. 2 is depicted in an enlarged representation.

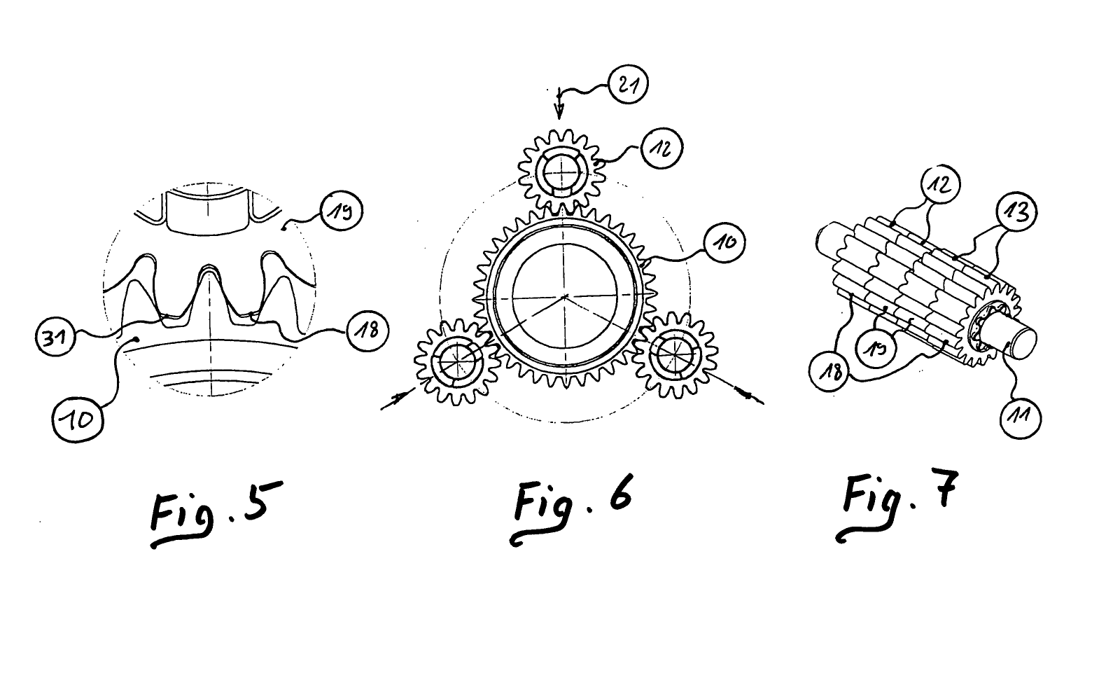

The planetary wheels and the sun wheel from the planetary transmission depicted in FIG. 2 are depicted in FIG. 6.

The planetary wheels from the planetary transmission depicted in FIG. 2 are depicted in FIG. 7.

In FIG. 8, a cut-out section from a first form of implementation of a planetary wheel is illustrated in further detail in a cross-section.

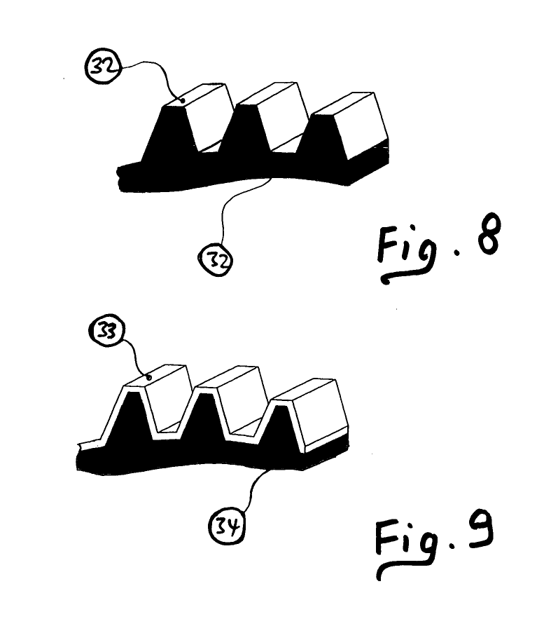

In FIG. 9, a cut-out section from a second form of implementation of a planetary wheel is illustrated in further detail in a cross-section.

### DETAILED DESCRIPTION OF THE DRAWINGS

FIG. 1 depicts one case of application in an electromechanical superimposition steering unit. Here, the transmission (1) is integrated into the divided steering column (3) of a conventional steering system (4). Through the engagement of a positioned E-motor (5), an additional or reduced steering angle (6) can be produced on the front wheels (7) (variable steering transmission) by the transmission (1). By means of the steering transmission, the steering behavior can be configured in a direct (agile) or an indirect manner, depending on the driving situation. Dynamic driving steering engagements can likewise be achieved by that means.

The superimposition transmission depicted in further detail in FIG. 2 is a planetary transmission with a variable adjusting means for setting the overload angle.

The transmission (1) essentially consists of a primary transmission shaft (9), sun wheel 1 (10), planetary carrier (11), planetary wheels (12/13), sun wheel 2 (14), transmission output shaft (15), transmission casing 1 (16), and transmission casing 2 (17).

The sun wheels (10/14) and the gear shafts (9/15) can be designed as a single part.

A low-noise operation of the transmission is achieved, in accordance with the invention, through the division of the sun wheels (12/13) into a plastic part (18) and a metal part (19).

The plastic part (18) and the metal part (19) of the specific planetary wheels (12/13) are equal in regard to the number of their teeth, while the plastic part (18), on the other hand, is radially offset from the metal part (19) by a positive profile displacement (see FIG. 5). As the result of this, only the plastic part (18) comes into contact with the corresponding sun wheels (10/14). The metal part (19) serves only for the transmission of momentum outside the nominal steering momentum range, and as security against an overload in the event of momentum from misuse. The plastic part (18) is deformed in the elastic area, and the corresponding metal part (19) comes into contact with the sun wheels (10/14). Both of the planetary wheels (12/13), as well as the metal part (19), are connected with one another in a form-locking and force-locking manner.

The operation of the transmission (1), which is free of clearance over the entire length of operation, is ensured by a contact force (Fr), which is defined radially on the planetary carrier superimposition transmission (20) and the planetary carrier (11) (see FIG. 6). The radial force is preferably produced by means of a spring element (22) integrated into the transmission casing (16/17).

No axial forces arise because of the straight gear teeth of the transmission (1), and these can be kept in their position, free of clearance, by means of a contact part (24) integrated into the transmission casing (16/17).

A movable bearing (25) integrated into both of the gear shafts (9/15) stabilizes the central axes (26) with one another. Both of the solid supports (27) are firmly integrated into the transmission casings (16/17) and fix the sun wheels (10/14) axially.

The gearing (toothed belt or spur-toothed gear) (28) of the drive (29) is, preferably, directly integrated with the transmission casing (16).

The geometry of the coupling (30) applied to the transmission casing (14) makes possible the application of a locking unit which, in the event of an error, blocks the transmission casing (10/14), in a power-free manner, from rotating and prevents a superimposed steering engagement.

A simple axial mounting of the transmission (1) is provided by the straight gearing and the divided transmission casing.

The planetary transmission depicted in FIG. 2 is schematically depicted, in cross-section, in FIG. 3. Thus, identical elements are also provided with the same reference numbers. Furthermore, a variable superimposition transmission regulating motor (5), which drives the transmission (1) or the casing of the transmission, respectively, by means of a toothed gear (29) and a toothing (28), is depicted in FIG. 3.

In FIG. 4, the planetary transmission depicted in FIG. 2 is depicted in a section along the rotational axis of the transmission. Thus, identical elements are also provided with the same reference numbers.

In FIG. 5, a cut-out section from the planetary transmission depicted in FIG. 2, in the area of the planetary wheels, is depicted in enlarged representation. Thus, identical elements are also provided with the same reference numbers. Cut-out sections from the plastic part (18) and from the metal part (19) of the corresponding planetary wheels (12/13) are to be noted. The plastic part (18) is offset radially from the metal part (19) by means of a positive profile displacement (31). As the result of this, only the plastic part (18) comes into contact with the corresponding sun wheels (10/14).

The planetary wheels and the sun wheel from the planetary transmission depicted in FIG. 2 are depicted in FIG. 6. Thus, identical elements are also provided with the same reference numbers. In this cut-out section, it is shown how the clearance-free operation of the transmission (1) is ensured by means of a contact force (Fr) (21), which is radially defined on the planetary carrier superimposition transmission (20) and the planetary carrier (11). The radial force (21) is defined in such a manner that, in the nominal steering momentum range, the plastic part (18) of both planetary wheels (12/13) meshes with both sun wheels (10/14) in a manner free of clearance. A jerking-free and comfortable operation of the transmission (1) results from the radial non-rigid suspension of the planetary wheels (12/13).

The planetary wheels for the planetary transmission depicted in FIG. 2 are depicted in FIG. 7. Thus, identical elements are also provided with the same reference numbers. Here, the division of the sun wheels (12/13) into a plastic part (18) and a metal part (19), where the planetary wheels (12/13) and the metal part (19) are connected with one another in a form-locking and force-locking manner, can be noted in further detail.

Through the division of the planetary wheels into a plastic part and a metal part, and the corresponding profile displacement, a low-noise operation of the planetary wheel transmission is essentially achieved, in an advantageous manner, with a steering engagement (comfort) comparable to normal steering behavior, in a non-active superimposition steering unit (transmission ratio of the transmission approx. 1:1), with clearance-free operation of the planetary wheel transmission and with steering engagement (comfort) and a high security against overload, in addition to the normal steering momentum range (momentum of misuse). The increase in comfort that is thereby achieved is additionally increased through the fact that the planetary units are suspended, in a supported manner, within a packet of springs.

A cut-out section from a first form of implementation of a toothed gear is depicted in further detail, in cross-section, in FIG. 8. Here, the toothed gear consists of a single material (32), such as a plastic for a first toothed gear, for example, or a metallic material of a second toothed gear of the transmission.

A cut-out section from a second form of implementation of a toothed gear is depicted in further detail in a cross-section in FIG. 9, where, in this case, the surface of the toothed gear has a coating (33) of an elastic material, and the core (34) consists of a metallic material.

1-16. (canceled)

17. A superimposition transmission for a superimposition steering unit of a vahicle, in which a steering angle set by the vehicle driver can, be superimposed by an additional angle, the transmission comprising at least two toothed gears, wherein at least a first toothed gear is designed with reference to low noise level and assumes the transmission of force in the case of normal transmission function, and that, at least a second toothed gear is designed with reference to the transmission of force in the event of an overload of the transmission function.

18. The transmission according to claim 17, wherein the first toothed gear is designed to optimize at least one parameter out of the group consisting of low vibration level and low clearance.

19. The transmission according to claim 17, wherein the event of a transmission function overload is present if a specific momentum boundary value is exceeded, which the transmission does not exceed during normal operation.

20. The transmission according to claim 17, wherein the second toothed gear comes into engagement after a specific elastic deformation of the first toothed gear.

21. A superimposition transmission according to claim 17, wherein at least one first toothed gear and one second toothed gear are provided in the transmission, where the first and the second toothed gears have different physical characteristics.

22. The transmission according to claim 17, wherein the second toothed gear is harder than the first toothed gear.

23. The transmission according to claim 17, wherein the second toothed gear is more stable in its shape than the first toothed gear.

24. The transmission according to claim 17, wherein the first and second toothed gears have different moduli of elasticity (E-moduli).

25. The transmission according to claim 17, wherein, for making the first and the second toothed gear, at least in part, different materials are used.

26. The transmission according to claim 25, wherein a metallic material and a plastic are used as the different materials.

27. The transmission according to claim 17, wherein the first and the second toothed gears are positioned axially offset from one another.

28. The transmission according to claim 27, wherein the first toothed gear is offset radially from the second toothed gear by a positive profile displacement.

29. The transmission according to claim 17, wherein the transmission has a straight gearing.

30. The transmission according to claim 17, wherein the transmission is a planetary transmission.

31. The transmission according to claim 14, wherein the first and the second toothed gears are planetary wheels in the planetary transmission.

32. The transmission according to claim 15, wherein the first and the second planetary wheels have a radially non-rigid suspension or support bearing.
